(19) United States
(12) Patent Application Publication
(10) Pub. No.: US 2006/0219756 A1
(43) Pub. Date: Oct. 5, 2006

(54) Active binder for brazing, part for brazing employing the binder, brazed product obtained with the binder, and silver brazing material

(76) Inventors: Kaoru Tada, Kanagawa (JP); Mituo Kawai, Kanagawa (JP)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 10/566,923

(22) PCT Filed: Aug. 2, 2004
(86) PCT No.: PCT/JP04/11051

§ 371 Date: Feb. 1, 2006

(30) Foreign Application Priority Data
Aug. 2, 2003 (JP) 2003-313264
Aug. 4, 2003 (JP) 2003-314792
Aug. 25, 2003 (JP) 2003-341825
Feb. 3, 2004 (JP) 2004-059778
Jun. 30, 2004 (JP) 2004-220962

(51) Int. Cl. A47J 36/02

(52) U.S. Cl. 228/101

(57) ABSTRACT

An active binder for brazing which is for use in brazing metals to ceramics; a ceramic part for brazing to which the binder has been applied; a brazed product; and a foil-form brazing material for use in producing a brazed metal/ceramic product. The active binder contains particles of either an active metal or a compound thereof (preferably titanium hydride) added thereto. The part for brazing comprises a part made of a ceramic and particles of either an active metal or a compound thereof which have been fixed to the ceramic part in at least the brazing area through a binder. The brazed product is produced by superposing the brazing area in the part for brazing on the brazing area in a metal part and then heating them in a furnace to melt the brazing particles and thereby braze the parts together.

### TECHNICAL FIELD

The present invention relates to an active binder for brazing to be used at the time of brazing a metal and a ceramic. The present invention also relates to a brazing product (a brazing ceramic part) using the above-mentioned active binder and a brazed product brazed with the brazing part (metal-ceramic brazed part). Further, the present invention relates to a silver brazing material to be used at the time of producing a heat sink for releasing heat of a semiconductor device and other brazed products of a metal and a ceramic.

### PRIOR ART

Conventionally, as a method of brazing a ceramic and a metal has been known a method of brazing a metal using a silver brazing or other brazing materials after treatment so-called metallization is carried out for the face of a ceramic to be brazed, however the metallization treatment requires processes and increases the cost and therefore, recently, a method of brazing a heat sink for releasing heat of a semiconductor device and other metals and ceramics by using a brazing material so-called active braze has been employed.

In the case of brazing a metal and a ceramic by using an active silver braze, the brazing is carried out generally by applying a paste type active silver brazing material obtained by kneading a silver powder, a copper powder, and a titanium hydride powder with a binder to a bonding face of a copper plate or a ceramic plate, butting the bonding face to a counterpart to be brazed, and heating and melting the brazing material in a furnace. In this case, the brazing is made possible by activating the portion of the ceramic to be brazed by 1.5% to 2% of titanium contained in the active silver braze.

Utilizing the activation function of titanium, an active braze obtained by kneading a nickel braze or a copper braze with titanium hydride similar to the active silver braze is also developed. Further, paste type active silver brazing materials using a silver braze powder, which is an alloy of silver and copper, in place of the silver powder and the copper powder and paste type active silver brazing materials using powders of active metals or their compounds in place of the titanium hydride powder have also been developed.

On the other hand, as a heat sink for releasing heat of a semiconductor device, those which are produced by bonding a copper plate and a ceramic plate by so-called direct bonding method have conventionally been used, and aluminum nitride and silicon nitride have been developed as ceramics.

Along with the increase of the output power of semiconductor devices, it has been desired to develop a heat sink with improved heat releasing capability by thickening a copper plate, however it is difficult for the direct bonding method to make the copper plate thick and therefore, a heat sink excellent in the bonding strength of the brazed part of the metal and the ceramic and also excellent in the heat conductivity has been desired.

As a method for producing a heat sink with a thickened copper plate, paste type active silver brazing material tends to be used recently.

However, the active braze is costly and if the amount of the brazing material is saved, the amount of titanium needed for activation of the portion of the ceramic to be brazed tends to be insufficient and consequently, sufficient brazing strength cannot be disadvantageously obtained.

Further, to improve the bonding strength of the metal and the ceramic, it is said to be effective that the concentration of the active metal element such as titanium contained in the active silver braze is increased, however it adversely results an inconvenience of decrease of toughness and heat conductivity of the brazed material if the concentration of the active metal becomes high.

As a method of applying the paste type active silver braze to the portion of the metal or the ceramic to be brazed have been known a method by a dispenser or a method of screen printing, however since it is difficult for the method using the dispenser to apply the paste type active silver braze thinly and evenly, generally a method of screen printing has been employed. However, in the case of the method of the screen printing, it is difficult to prevent striking of the paste type brazing material to the outer circumferential part at the time of application work if the copper plate and the ceramic plate becomes thick and also it requires a troublesome work for removing the paste type brazing material adhered to a squeegee and a screen.

For that, as a method of solving the inconvenience of application of the paste type active silver brazing material by the dispenser method and the screen printing method has been investigated a method of brazing by producing a thin sheet or foil of an active silver braze containing about 2% by weight of an active metal such as titanium and zirconium, sandwiching the sheet or foil between the ceramic and the metal, and carrying out heating in a furnace.

However, the alloy containing the active metal such as titanium is inferior in the ductility and cracking is caused at the time of rolling and therefore, the production of the thin sheet or foil of the alloy containing the active metal has been industrially problematic.

### DISCLOSURE OF THE INVENTION

The present invention aims to provide an active binder for brazing without any inconvenience in the case of using a paste type active braze for brazing a metal and a ceramic, capable of saving an amount of a brazing material to be used, brazing with good heat conductivity, and brazing a metal and a ceramic by using a brazing material containing no active metal element such as titanium.

Also, the present invention aims to solve the inconvenience at the time of active brazing of a ceramic and a metal using a paste type active brazing material and a thin sheet or foil of the active brazing material and provide an innovative and industrially usable brazing part (a ceramic part for active brazing).

Further, the present invention aims to solve the inconvenience at the time of applying the conventional paste type brazing material by a dispenser or screen printing method and provide a brazed product obtained by brazing a metal and a ceramic and having high bonding strength in the brazed part and excellent heat conductivity.

Further, the present invention aims to solve the inconvenience at the time of brazing a ceramic and a metal using a paste type active silver brazing material and provide an innovative and industrially usable silver brazing material.

An active binder for brazing of the present invention is to be used at the time of brazing a metal part made of a metal and a ceramic part made of a ceramic and is characterized in that a powder of an active metal or its compound is added to and mixed with the binder.

The active binder for brazing of the present invention having the above-mentioned characteristic is further characterized in that the binder is a water-based binder and the compound of the active metal is titanium hydride (TiH₂).

A part for brazing of the present invention is a part made of a ceramic to be used at the time of being brazed with a metal part made of a metal and is characterized in that a powder of an active metal or its compound is firmly fixed in at least the portion of the part to be brazed by a binder.

The part for brazing of the present invention having the above-mentioned characteristic is further characterized in that the compound of the active metal is titanium hydride and the ceramic is aluminum nitride or silicon nitride.

A brazed product of the present invention is a product obtained by brazing a metal part made of a metal and ceramic part made of a ceramic and is characterized in that the brazing is carried out by overlaying a ceramic part obtained by applying a active binder for brazing obtained by adding and mixing a powder of an active metal or its compound to and with a water-based binder to the portion of the ceramic part to be brazed and spreading and firmly fixing a brazing powder to the binder on the portion of the metal part, the counterpart, to be brazed together, and then melting the brazing powder by heating in a furnace.

The brazed product of the present invention having the above-mentioned characteristic is further characterized in that the metal part is made of copper or a copper alloy: the ceramic part is made of aluminum nitride or silicon nitride: and the brazing powder is a silver brazing powder.

A silver brazing material of the present invention comprises a foil type substrate of a silver braze (a thin sheet or a foil) and a powder of an active metal or its compound firmly bonded to at least one face of the substrate through a binder.

The silver brazing material of the present invention having the above-mentioned characteristic is further characterized in that the compound of the active metal is titanium hydride.

### BEST MODE FOR CARRYING OUT OF THE INVENTION

At first, the active binder for brazing of the present invention will be described.

The active binder for brazing of the present invention contains a binder and a powder of an active metal or its compound added to and mixed with the binder and is capable of carrying out silver brazing of a ceramic and a metal by applying the binder to a portion of the ceramic to be brazed; spreading a commercialized silver brazing powder thereon after the coating or putting a thin sheet or foil of a silver braze in place of the silver brazing powder; further putting a metal to be brazed thereon; and carrying out brazing by heating in a furnace. The active binder for brazing of the present invention is further capable of carrying out brazing of a ceramic and a metal by applying the binder to a portion of the ceramic to be brazed; spreading a commercialized copper brazing powder or nickel brazing powder thereon after the coating or putting a thin sheet or foil of a copper braze in place of the copper brazing powder; further putting a metal to be brazed thereon; and carrying out brazing by heating in a furnace.

Since use of the active binder for brazing of the present invention makes it possible to supply an activation substance such as titanium needed for activating the portion of the ceramic to be brazed to the surface of the portion of the ceramic to be brazed, brazing of the metal and the ceramic is made possible by using a brazing material containing no active substance such as titanium. Further, the thickness of the brazing material in the portion to be brazed can be made thin and even if the thickness of the brazing material is made thin, sufficient brazing strength can be obtained.

Examples of the active metal of the present invention may include titanium and zirconium and examples of the compound of the active metal is hydrides of titanium and zirconium and titanium hydride is preferable in terms of easy availability and safety.

The binder to be used for the active binder for brazing of the present invention may be organic solvent type binders and water-based binders if they can firmly fix the active substance such as titanium hydride to the portion of the ceramic to be brazed, however since the organic solvent type binders worsen the working environments by the malodor at the time of spraying the binders or brazing, the water-based binders are preferable and examples thereof are an aqueous polyethylene glycol solution, an aqueous vinyl alcohol polymer solution, and an aqueous cellulose ether solution and also synthetic water-soluble adhesives are also usable.

The viscosity of the active binder for brazing of the present invention may be lowered in the case where a spray is used for the application method of the binder to the portion of the ceramic to be brazed and may be increased in the case where application is carried out by a screen printing method and viscosity may be changed properly in accordance with absence or presence of a masking or the like.

The active binder for brazing of the present invention may be added to and mixed with a powder of zirconium hydride (ZrH₂) in place of the powder of titanium hydride (TiH₂) and these active metal powders are preferable to have a particle diameter of 10 μm or smaller. That is because if the particle diameter becomes extremely large exceeding 10 μm, the distribution of the active substance in the surface of the portion to be brazed becomes sparse and accordingly, the brazing characteristic is deteriorated.

In the case where silver brazing is carried out using the active binder for brazing of the present invention, the powder, the thin sheet or the foil of the silver braze to be used may be commonly used silver braze and silver braze with a lowered melting point by adding tin or indium.

In the case where nickel brazing is carried out using the active binder for brazing of the present invention, the powder of the nickel braze may be common nickel brazing powders defined in JIS Z 3265. In the case where copper brazing is carried out using the active binder for brazing of the present invention, the powder, the thin sheet or the foil of the copper braze to be used may be commonly used copper braze and copper braze with a lowered melting point by adding tin or silver.

Next, the part for brazing and the brazed product of the present invention will be described.

In the present invention, the reason for producing the part for brazing by firmly sticking the powder of the active metal or its compound to the portion of the ceramic to be brazed with a metal by a binder is because brazing is made possible if the active metal or its compound exists at least in the surface of the ceramic to be brazed at the time of brazing the metal and the ceramic.

If the part for brazing of the present invention is used, it is made possible to use a brazing material containing no active metal as the brazing material at the time of brazing.

The active metal of the present invention may be, for example, titanium, zirconium, or hafnium and the compound of the active metal may be, for example, hydrides of titanium and zirconium and titanium hydride is desirable in terms of easy availability and safety.

In the present invention, a method of firmly sticking the powder of the active metal or its compound to the surface of the ceramic part made of a ceramic to be brazed by the binder may be carried out by spraying a previously mixed mixture of the powder of the active metal or its compound and the binder to the surface of the ceramic to be brazed with a spray and then drying the mixture.

Also, the method may be carried out by applying the previously mixed mixture of the powder of the active metal or its compound and the binder to the surface of the ceramic to be brazed by a screen printing method and then drying the mixture.

In the present invention, the ceramic part is preferable to be made of aluminum nitride or silicon nitride and the reason for that is because these ceramics have excellent heat conductivity and electric insulation property and are therefore desirable for a heat sink for releasing heat of a semiconductor device.

To produce the brazed product of the present invention by brazing the above-mentioned part for brazing of the present invention with a metal part made of a metal, a method involving spraying the binder previously mixed with the powder of the active metal or its compound (e.g. titanium hydride powder) to the surface of the ceramic to be brazed with a spray; spreading and firmly sticking the brazing powder (e.g. a silver brazing powder, a nickel brazing powder, or a copper brazing powder) thereto; successively overlaying a metal part to be brazed to the portion; and carrying out brazing by heating them in a furnace is simple in the production steps and excellent in the safety and industrially advantageous since the materials to be used such as silver brazing powder and the titanium hydride powder are made easily available and the titanium hydride powder is used while being mixed in the binder.

In the case where a slurry type brazing material obtained by previously mixing the binder and the powder brazing material is applied by spraying, the slurry type brazing material scattered somewhere other than the part for brazing adheres to a coating apparatus and it makes collection and reuse difficult. Further, in the case where a powder brazing material application apparatus made of US Wall Colmonoy is used, the binder and the powder brazing material are separately supplied to the powder brazing material application apparatus and the powder brazing material is sprayed for mixing simultaneously with spraying of the binder, so that it becomes difficult to collect and reuse the powder brazing material scattered somewhere other than the part for brazing.

In the present invention, brazing may be carried out by spraying the binder mixed with the powder of the active metal or the powder of the active metal compound to the surface of the ceramic part to be brazed with a spray; on the other hand spraying the binder to the portion of the metal part to be brazed; spreading and firmly sticking the brazing powder; successively overlaying these portions to be brazed with each other; and heating them in a furnace.

In the present invention, brazing may be carried out by spraying the binder to the surface of the ceramic part to be brazed with a spray; spreading and firmly sticking the powder of the active metal or the powder of the active metal compound thereon; further spraying the binder thereon; spreading and firmly sticking the brazing powder; successively overlaying the metal part to be brazed thereon; and heating them in a furnace.

Also, in the present invention, a silver brazing thin sheet or foil to one face of which the powder of the active metal or the powder of the active metal compound in one face is firmly stuck by a binder is prepared and the ceramic part to be brazed is overlaid on the face to which the powder of the active metal or the powder of the active metal compound is firmly stuck and the metal part to be brazed is overlaid to the face in the opposed side and then they are heated in a furnace to braze the ceramic part and the metal part to each other.

At the time of producing the brazed product of the present invention, brazing may be carried out by firmly sticking the powder of the active metal or the powder of the active metal compound to the surface of the ceramic to be brazed by the binder; successively inserting the silver brazing thin sheet or foil between the surface of the ceramic and the metal to be brazed; and heating them in a furnace.

The silver brazing powder to be used at the time of producing the brazed product of the present invention may be an alloy powder of silver and copper as well as an alloy powder with a lowered melting point by adding indium, tin and the like, and also a silver brazing powder containing a slight amount of an active metal.

In the present invention, it is not desirable that the brazing powder and the binder are applied simultaneously or that a mixture of the brazing powder and the binder is previously produced and applied. The reason for that is because it becomes difficult to collect and reuse the brazing powder in both cases.

The method of spreading the brazing powder to the face to which the binder mixed with the powder of the active metal or the powder of the active metal compound is sprayed is desirable to be carried out by using a feeder apparatus employing an electromagnetic vibrator and an electrostrictive strain vibrator since it is simple and convenience.

In this connection, copper and a copper alloy is preferable as the metal part and the reason for that is because the have excellent heat conductivity and electric conductivity. On the other hand, aluminum nitride or silicon nitride is preferable for the ceramic part.

A practical example of the brazed product of the present invention is a heat sink for releasing heat of a semiconductor device, however the brazed product of the present invention is not limited to the heat sink.

Finally, the brazing material of the present invention suitable for silver brazing will be described.

The silver brazing material of the present invention is a silver brazing foil-like substrate (a thin sheet or a foil) to which a powder of an active metal or its compound (preferably titanium hydride) is firmly stuck through a binder in at least one face and the reason for using the silver brazing thin sheet or foil in the present invention is because a common silver braze can be processed into a thin sheet or foil by rolling although the active silver braze containing an active metal such as titanium as an alloying element cannot be processed to a thin sheet or a foil by rolling.

Further, the reason for firmly sticking the powder of the active metal or its compound to one face of the silver brazing thin sheet or foil by the binder in the present invention is because brazing can be carried out if the powder of the active metal or its compound exists at least in the surface of a ceramic to be brazed at the time of brazing a metal and the ceramic.

To produce the brazed product by using the above-mentioned brazing material of the present invention, brazing may be carried out by setting the face to which the powder of the active metal or its compound for the silver braze is firmly stuck on the opposite to the ceramic part between the metal part to be brazed and the ceramic part and heating them in a furnace.

The method for firmly sticking the powder of the active metal or its compound to the silver brazing thin sheet or foil by a binder may be carried out by spraying a previously mixed mixture of the powder of the active metal or its compound and the binder by a spray and then drying the mixture.

Also, the method may be carried out by spraying the binder to one face of the silver brazing thin sheet or foil with a spray and then spreading the powder of the active metal or its compound further thereon by using a feeder apparatus employing a vibration of an electromagnetic vibrator or the like and then drying them.

Further, the method may be carried out by applying the previously mixed mixture of the powder of the active metal or its compound and the binder to the surface of the ceramic to be brazed by a screen printing method and then drying the mixture.

In this case, the binder may be organic solvent type binders and water-based binders if they can firmly fix the powder of the active metal or its compound to the silver brazing thin sheet or foil. In this connection, since the organic solvent type binders worsen the working environments by the malodor, the water-based binders are preferable.

The silver brazing thin sheet or foil of the present invention may be made of an alloy of silver and copper and also an alloy having a lowered melting point by adding indium and tin and also a silver brazing material containing a small amount of an active metal.

Hereinafter, the present invention will be described more in detail with reference to Examples.

### EXAMPLES

A. Test Result of Brazing Using an Active Binder for Brazing of the Present Invention

### Example A1

An active binder for brazing was prepared by adding and mixing 8% by weight of a powder of titanium hydride with a particle diameter of 10 μm or smaller (particle diameter: about 5 to 10 μm) to and with a commercialized water-based binder (an aqueous polyvinyl alcohol solution) with a viscosity of 0.1 dPa·s. Also, one 20 mm square rod of aluminum nitride and oxygen-free copper each was made ready.

0.01 g of the active binder for brazing was sprayed to the 20 mm square face of the aluminum nitride by a spray and a silver brazing powder (72 Ag-28 Cu) of BAg-8 defined in JIS Z3261 was evenly spread by a vibration type feeder apparatus and then the binder was dried to firmly fix 0.04 g of the silver brazing powder. Next, the 20 mm square face of the oxygen-free copper was butted to the face where the silver brazing powder was firmly stuck and heated in a vacuum furnace for carrying out brazing.

A test specimen was sampled from the obtained brazed product and subjected to a bending test for the brazed part according to JIS. As a result, although the aluminum nitride was broken, no abnormality was observed in the brazed part and it was found that the brazing was carried out excellently. The thickness of the brazing part in the brazed material was 10 μm.

### Example A2

An active binder for brazing was prepared by adding and mixing 12% by weight of a powder of titanium hydride with a particle diameter of 10 μm or smaller to and with a commercialized organic solvent-based binder with a viscosity of 0.2 dPa·s. Also, one 20 mm square rod of silicon nitride and oxygen-free copper each was made ready.

0.01 g of the active binder for brazing was sprayed to the 20 mm square face of the silicon nitride by a spray and the silver brazing powder of BAg-18 was evenly spread and then the binder was dried to firmly fix 0.08 g of the silver brazing powder in the same manner as that in Example A1. Next, the 20 mm square face of the oxygen-free copper was butted to the face where the silver brazing powder was firmly stuck and heated in a vacuum furnace for carrying out brazing.

A test specimen was sampled from the obtained brazed product and subjected to a bending test for the brazed part according to JIS in the same manner as that in Example A1. As a result, although the silicon nitride was broken, no abnormality was observed in the brazed part and it was found that the brazing was carried out excellently. The thickness of the brazing part in the brazed material was 20 μm.

### Example A3

An active binder for brazing was prepared by adding and mixing 11% by weight of a powder of titanium hydride with a particle diameter of 10 μm or smaller to and with a commercialized water-based binder (an aqueous cellulose ether solution) with a viscosity of 70 dPa·s. Also, one 20 mm square rod of aluminum oxide and Kovar (Fe—Ni—Co alloy) each was made ready.

0.03 g of the active binder for brazing was applied to the 20 mm square face of the aluminum oxide by screen printing method and the same silver brazing powder of BAg-8 as that used in Example A1 was evenly spread and then the binder was dried to firmly fix 0.13 g of the silver brazing powder. Next, the 20 mm square face of Kovar was butted to the face where the silver brazing powder was firmly stuck and heated in a vacuum furnace for carrying out brazing.

A test specimen was sampled from the obtained brazed product and subjected to a bending test for the brazed part according to JIS in the same manner as that in Example A1. As a result, although the aluminum oxide was broken, no abnormality was observed in the brazed part and it was found that the brazing was carried out excellently. The thickness of the brazing part in the brazed material was 30 μm.

### Example A4

An active binder for brazing was prepared by adding and mixing 10% by weight of a powder of zirconium hydride with a particle diameter of 10 μm or smaller to and with a commercialized water-based binder same as that used in Examples A1. Also, one 20 mm square rod of aluminum nitride and oxygen-free copper each was made ready.

0.01 g of the active binder for brazing was sprayed to the 20 mm square face of the aluminum nitride by a spray and the silver brazing powder of BAg-8 was evenly sprayed and then the binder was dried to firmly fix 0.06 g of the silver brazing powder, in the same manner as that in Example A1. Next, the 20 mm square face of the oxygen-free copper was butted to the face where the silver brazing powder was firmly stuck and heated in a vacuum furnace for carrying out brazing.

A test specimen was sampled from the obtained brazed product and subjected to a bending test for the brazed part according to JIS in the same manner as that in Example A1. As a result, although the aluminum nitride was broken, no abnormality was observed in the brazed part and it was found that the brazing was carried out excellently. The thickness of the brazing part in the brazed material was 15 μm.

### Example A5

An active binder for brazing was prepared by adding and mixing 8% by weight of a powder of titanium hydride with a particle diameter of 10 μm or smaller to and with a commercialized water-based binder same as that used in Examples A1. Also, one 20 mm square rod of silicon nitride and SUS304 each was made ready.

0.03 g of the active binder for brazing was sprayed to the 20 mm square face of the silicon nitride by a spray and a nickel brazing powder of BNi-2 defined in JIS Z3265 was evenly spread by a vibration type feeder apparatus and then the binder was dried to firmly fix 0.11 g of the nickel brazing powder. Next, the 20 mm square face of the SUS304 was butted to the face where the nickel brazing powder was firmly stuck and heated in a vacuum furnace for carrying out brazing.

A test specimen was sampled from the obtained brazed product and subjected to a bending test for the brazed part according to JIS. As a result, although the silicon nitride was broken, no abnormality was observed in the brazed part and it was found that the brazing was carried out excellently. The thickness of the brazing part in the brazed material was 30 μm.

### Example A6

An active binder for brazing was prepared by adding and mixing 12% by weight of a powder of titanium hydride with a particle diameter of 10 μm or smaller to and with a commercialized organic solvent type binder with a viscosity of 0.2 dPa·s. Also, one 20 mm square rod of aluminum nitride and oxygen-free copper each was made ready.

0.02 g of the active binder for brazing was sprayed to the 20 mm square face of the aluminum nitride by a spray in the same manner as that in Example A1 and a copper brazing powder containing 20% by weight of tin and balance Cu and inevitable impurities was evenly sprayed and then the binder was dried to firmly fix 0.07 g of the copper brazing powder. Next, the 20 mm square face of the oxygen-free copper was butted to the face where the copper brazing powder was firmly stuck and heated for carrying out brazing.

A test specimen was sampled from the obtained brazed product and subjected to a bending test for the brazed part according to JIS in the same manner as that in Example A1. As a result, although the aluminum nitride was broken, no abnormality was observed in the brazed part and it was found that the brazing was carried out excellently. The thickness of the brazing part in the brazed material was 20 μm.

### Example A7

An active binder for brazing was prepared by adding and mixing 11% by weight of a powder of titanium hydride with a particle diameter of 10 μm or smaller to and with a commercialized water-based binder with a viscosity of 70 dPa·s. Also, one 20 mm square rod of aluminum oxide and Kovar each was made ready.

0.03 g of the active binder for brazing was applied to the 20 mm square face of the aluminum oxide by screen printing method and a copper brazing powder containing 8% by weight of tin and balance copper and inevitable impurities was evenly spread thereon and then the binder was dried to firmly fix 0.12 g of the copper brazing powder. Next, the 20 mm square face of Kovar was butted to the face where the copper brazing powder was firmly stuck and heated for carrying out brazing.

A test specimen was sampled from the obtained brazed product and subjected to a bending test for the brazed part according to JIS in the same manner as that in Example A1. As a result, although the aluminum oxide was broken, no abnormality was observed in the brazed part and it was found that the brazing was carried out excellently. The thickness of the brazing part in the brazed material was 30 μm.

### Comparative Example A1

After 0.02 g of the commercialized water-based binder same as that used in Example A1 was sprayed to the 20 mm square face of the 20 mm square rod of aluminum nitride by a spray and the silver brazing powder of BAg-8 same as that used in Example A1 was evenly spread thereon and then the binder was dried to firmly stick 0.09 g of the silver brazing powder.

Next, a 20 mm square rod of oxygen-free copper was butted to the face where the silver brazing powder was firmly stuck and heated in a vacuum furnace for brazing, however the brazing could not be done.

### Comparative Example A2

After 0.02 g of the commercialized water-based binder same as that used in Example A1 was sprayed to the 20 mm square face of the 20 mm square rod of aluminum nitride by a spray and the nickel brazing powder of BNi-2 same as that used in Example A5 was evenly spread thereon and then the binder was dried to firmly stick 0.11 g of the nickel brazing powder.

Next, a 20 mm square rod of oxygen-free copper was butted to the face where the nickel brazing powder was firmly stuck and heated in a vacuum furnace for brazing, however the brazing could not be done.

B. Test Result of Brazing Using a Part for Brazing of the Present Invention

### Example B1

One 20 mm square rod of aluminum nitride and oxygen-free copper each was made ready and 0.01 g of a water-based binder (an aqueous polyvinyl alcohol solution) mixed with 10% by weight of the titanium hydride fine powder same as that of Example A1 was sprayed to the 20 mm square face of the aluminum nitride by a spray and then 0.08 g of a silver brazing powder containing 27.4% by weight of copper and the balance silver and inevitable impurities and having an average particle diameter of 35 μm was evenly spread thereon by an electromagnetic type feeder. Successively, the 20 mm square face of the oxygen-free copper was butted to the face where the silver brazing powder was spread and firmly stuck and heated in a vacuum furnace for carrying out brazing.

A test specimen was sampled from the obtained brazed product and subjected to a bending test according to JIS. As a result, although the aluminum nitride was broken, no abnormality was observed in the brazed part and it was found that the brazing was carried out excellently.

### Example B2

One 20 mm square rod of silicon nitride and oxygen-free copper each was made ready and 0.03 g of a water-based binder mixed with 11% by weight of the titanium hydride fine powder same as that of Example A3 was sprayed to the 20 mm square face of the silicon nitride by the screen printing method and then 0.14 g of a silver brazing powder containing 23.8% by weight of copper, 14.1% by weight of indium, and the balance silver and inevitable impurities and having an average particle diameter of 35 μm was evenly spread by an electromagnetic feeder. Successively, the 20 mm square face of the oxygen-free copper was butted to the face where the silver brazing powder was spread and firmly stuck and heated in a vacuum furnace for carrying out brazing.

A test specimen was sampled from the obtained brazed product and subjected to a bending test according to JIS. As a result, although the silicon nitride was broken, no abnormality was observed in the brazed part and it was found that the brazing was carried out excellently.

### Example B3

Aluminum nitride in a size of 25×25×0.6 mm and oxygen-free copper in a size of 25×25×1 mm were prepared and 0.01 g of a water-based binder mixed with 15% by weight of the titanium hydride fine powder was sprayed to the 25 mm square face of the aluminum nitride by a spray and then 0.11 g of a silver brazing powder containing 27.4% by weight of copper and the balance silver and inevitable impurities and having an average particle diameter of 35 μm was spread and firmly stuck thereto by an electromagnetic feeder. Successively, the oxygen-free copper was overlapped to the face where the silver brazing powder was spread and firmly stuck and heated in a vacuum furnace for carrying out brazing.

The bonding part of the obtained brazed product was examined by ultrasonic test to find no pin hole or blow hole and it was confirmed that the brazing was carried out excellently.

### Example B4

One 20 mm square rod of aluminum nitride and oxygen-free copper each was made ready and 0.01 g of a water-based binder mixed with 10% by weight of the titanium hydride fine powder was sprayed to the 20 mm square face of the aluminum nitride by a spray and then dried. Next, a silver brazing foil with a thickness of 20 μm containing 27.1% by weight of copper and the balance silver and inevitable impurities was prepared and the foil was sandwiched between the 20 mm square face of the aluminum nitride where the titanium hydride was firmly stuck and the 20 mm square face of the oxygen-free copper and heated in a vacuum furnace for carrying out brazing.

A test specimen was sampled from the obtained brazed product and subjected to a bending test according to JIS. As a result, although the aluminum nitride was broken, no abnormality was observed in the brazed part and it was found that the brazing was carried out excellently.

### Example B5

One 20 mm square rod of silicon nitride and oxygen-free copper each was made ready and 0.01 g of a water-based binder mixed with 10% by weight of the titanium hydride fine powder was sprayed to the 20 mm square face of the silicon nitride by a spray and then dried. On the other hand, 0.01 g was of a water-based binder sprayed to the 20 mm square face of the oxygen free copper by a spray and then 0.08 g of a silver brazing powder manufactured by atomization containing 27.4% by weight of copper and the balance silver and inevitable impurities and having an average particle diameter of 35 μm was spread thereon by an electromagnetic feeder and then the binder was dried.

Successively, the face of the silicon nitride to which the titanium hydride was firmly stuck and the face of the oxygen-free copper to which the silver brazing powder was firmly stuck were butted to each other and they were brazed by heating in a vacuum furnace.

A test specimen was sampled from the obtained brazed product and subjected to a bending test according to JIS. As a result, although the silicon nitride was broken, no abnormality was observed in the brazed part and it was found that the brazing was carried out excellently.

C. Test Result of Brazing Using a Silver Brazing Material of the Present Invention

### Example C1

A thin sheet with a thickness of 20 μm of a silver braze containing 27.4% by weight of copper and the balance silver and inevitable impurities was produced by rolling. A commercialized water-based binder (an aqueous polyvinyl alcohol solution) mixed with 15% by weight of titanium hydride fine powder same as that used in Example A1 was sprayed to one face of the silver braze and dried to prepare an active silver brazing material firmly bearing the titanium hydride powder. Also, one 25 mm square rod of aluminum nitride and oxygen-free copper each was made ready.

Successively, the active silver brazing material previously prepared as described was inserted between the 25 mm square faces of the aluminum nitride and the oxygen-free copper in the manner that the face where the titanium hydride powder was firmly stuck was set in the aluminum nitride side and brazing was carried out by heating in a vacuum furnace.

A test specimen was sampled from the obtained brazed product and subjected to a bending test according to JIS. As a result, although the aluminum nitride was broken, no abnormality was observed in the brazed part and it was found that the brazing was carried out excellently.

### Example C2

A silver braze thin sheet with a thickness of 20 μm same as that of Example C1 was produced and a commercialized organic solvent type binder mixed with 10 by weight of titanium hydride fine powder was sprayed to one face of the sheet with a spray and then dried to prepare an active silver brazing material firmly bearing the titanium hydride powder. Also, one 25 mm square rod of silicon nitride and oxygen-free copper each was made ready.

Successively, the active silver brazing material previously prepared as described was inserted between the 25 mm square faces of the silicon nitride and the oxygen-free copper in the manner that the face where the titanium hydride powder was firmly stuck was set in the silicon nitride side and brazing was carried out by heating in a vacuum furnace.

A test specimen was sampled from the obtained brazed product and subjected to a bending test according to JIS. As a result, although the silicon nitride was broken, no abnormality was observed in the brazed part and it was found that the brazing was carried out excellently.

### Example C3

A thin sheet with a thickness of 20 μm of a silver braze containing 23.7% by weight of copper, 14.3% by weight of indium, and the balance silver and inevitable impurities was produced by rolling. A water-based binder mixed with 11% by weight of titanium hydride fine powder same as that used in Example A3 was applied to one face of the silver braze by the screen-printing method and then dried to prepare an active silver brazing material firmly bearing the titanium hydride powder. Also, aluminum nitride in a size of 25×25×0.6 mm and oxygen-free copper in a size of 25×25×1 mm were prepared.

The active silver brazing material was inserted between the 25 mm square faces of the aluminum nitride and the oxygen-free copper in the manner that the face where the titanium hydride powder was firmly stuck was set in the aluminum nitride side and brazing was carried out by heating in a vacuum furnace.

The bonding part of the obtained brazed product was examined by ultrasonic test to find no pin hole or blow hole and it was confirmed that the brazing was carried out excellently.

### INDUSTRIAL APPLICABILITY

Use of the active binder for brazing of the present invention makes excellent brazing possibly since titanium hydride which activates ceramics and makes brazing easy efficiently works on the surface of a ceramic to be brazed and makes brazing of a metal and a ceramic possible without using a costly active brazing material and thus the present invention is very advantageous in industrial fields. In the case of using the active binder for brazing of the present invention for silver brazing, the thickness of the silver braze in a part to be brazed can be made thin and brazing with excellent heat conductivity is made possible.

In the case of using a ceramic part for brazing of the present invention, the inconvenience of application process in the case where a paste type active silver braze is used can be solved and also active silver brazing can be carried out by using a silver brazing material containing no active metal and the bonding strength and the heat conductivity of the brazed part of a metal and a ceramic can be improved and thus the present invention is very advantageous in industrial fields.

Further, the active silver brazing material of the present invention can solve the inconvenience of use of a paste type active silver braze and make it possible to carry out a brazing work of a metal and a ceramic easily at an increased the working speed in mass production and thus the present invention is very advantageous in industrial fields.

1. An active binder for brazing to be used at the time of brazing a metal part made of a metal and a ceramic part made of a ceramic, wherein a powder of the active metal or its compound is added and mixed.

2. The active binder for brazing according to claim 1, wherein the binder is a water-based binder and the compound of the active metal is titanium hydride.

3. A part for brazing made of a ceramic to be used at the time of brazing with a metal part made of a metal, wherein a powder of the active metal or its compound is firmly stuck through a binder to at least a portion of the part to be brazed.

4. The part for brazing according to claim 3, wherein the compound of the active metal is titanium hydride and the ceramic is aluminum nitride or silicon nitride.

5. A brazed product obtained by brazing a metal part made of a metal and a ceramic part made of a ceramic, wherein the brazing is carried out by applying an active binder for brazing prepared by adding and mixing a powder of the active metal or its compound to and with a water-based binder to the surface of the ceramic part to be brazed; overlaying the ceramic part obtained by spreading and firmly sticking a brazing powder to the binder thereafter and a portion of the metal part, the counterpart, to be brazed; and melting the brazing powder by heating them in a furnace.

6. The brazed product according to claim 5, wherein the metal part is made of copper or a copper alloy, the ceramic part is made of aluminum nitride or silicon nitride, and the brazing powder is a silver brazing powder.

7. A silver brazing material comprising a foil-like substrate of a silver braze and a powder of the active metal or its compound firmly stuck to at least one face of the substrate through a binder.

8. The silver brazing material according to claim 7, wherein the compound of the active metal is titanium hydride.
